(19) United States
(12) Patent Application Publication
(10) Pub. No.: US 2006/0202066 A1
(43) Pub. Date: Sep. 14, 2006

(54) Fluid injection valve

(75) Inventor: Shinsuke Yamamoto, Kariya-city (JP)

Correspondence Address: NIXON & VANDERHYE, PC, 901 NORTH GLEBE ROAD, 11TH FLOOR, ARLINGTON, VA, 22203, US

(73) Assignee: Denso Corporation, Kariya-city (JP)

(21) Appl. No.: 11/352,358

(22) Filed: Feb. 13, 2006

(30) Foreign Application Priority Data
Mar. 9, 2005 (JP) 2005-64946

(51) Int. Cl. F02M 51/00

(52) U.S. Cl. 239/585.1

(57) ABSTRACT

In a fluid injection valve, a fuel filter is installed in an upstream portion of the housing. A valve element is slidably installed in the housing to lift off and seat on a valve seat provided at a downstream portion of the housing. A passage portion is provided in the housing between the fuel filter and the valve element to face the fuel filter and has an opening portion at an upstream end thereof. An inner width of the opening portion is narrower than a bore of the upstream portion of the housing. A distance between the opening portion and the fuel filter is 4.5 mm or greater.

### CROSS REFERENCE TO RELATED APPLICATION

This application is based upon and claims the benefit of priority of Japanese Patent Application No. 2005-064946 filed on Mar. 9, 2005, the content of which is incorporated herein by reference.

### FIELD OF THE INVENTION

The present invention relates to a fluid injection valve suitable for injecting fuel into cylinders of an internal combustion engine (hereinafter referred to just as engine).

### BACKGROUND OF THE INVENTION

U.S. Pat. No. 4,984,744 and its counterpart JP-H02-195084, for example, disclose a fuel injection valve in which an electromagnetic driving portion reciprocatingly drives a valve element to start and stop injecting fuel. In this kind of the fuel injection valve, a hitting sound is generated when the valve element seats on a valve seat in a valve-closing time, or when the valve element or a moving core is engaged with a stopper in a valve-opening time, for example. Thus, the fuel injection valve causes an issue of noise if the operational sound generated inside the fuel injection valve are propagated to an outside of the fuel injection valve.

In this regard, in another fuel injection valve 300 shown in FIG. 7, a fuel filter 310 is installed at a fuel inflow port 304 of a fuel passage 302 to block an exit of the sound, which is generated inside the fuel injection valve 300 in accordance with a reciprocating motion of the valve element 320. However, a vibration of the sound, which is spread over an entire of the fuel passage 302, diffracts to an outer circumferential side of the fuel filter 310 and passes through the fuel filter 310 to be propagated to the outside of the fuel injection valve 300, so that it is impossible to reduce the noise.

### SUMMARY OF THE INVENTION

The present invention is achieved to solve the above-mentioned issue, and has an object to provide a fluid injection valve that reduces the sound propagated from an inside of the fuel injection valve to the outside.

The fluid injection valve has a housing, a fuel filter, a valve element, a passage portion and an electromagnetic driving portion. The housing is provided with a valve seat at a downstream portion thereof. The fuel filter is installed in an upstream portion of the housing. The valve element is slidably installed in the housing to lift off and seat on the valve seat. The passage portion is provided in the housing between the fuel filter and the valve element to face the fuel filter and has an opening portion at an upstream end thereof. An inner width of the opening portion is narrower than a bore of the upstream portion of the housing. A distance between the opening portion and the fuel filter is 4.5 mm or greater. The electromagnetic driving portion drives the valve element to open and close the valve seat.

### BRIEF DESCRIPTION OF THE DRAWINGS

Features and advantages of embodiments will be appreciated, as well as methods of operation and the function of the related parts, from a study-of the following detailed description, the appended claims, and the drawings, all of which form a part of this application. In the drawings:

FIG. 1 is a cross-sectional view showing an entire construction of a fluid injection valve according to a first embodiment of the present invention;

FIG. 2 is a top view of an adjusting pipe of the fluid injection valve according to the first embodiment, which is seen from a side of a fuel filter;

FIG. 3 is a graph showing a sound pressure characteristic of an operational noise of the fluid injection valve according to the first embodiment relative to a distance L between the adjusting pipe and the fuel filter;

FIG. 4 is a top view of an adjusting pipe of a fluid injection valve according to a second embodiment of the present invention, which is seen from a side of a fuel filter;

FIG. 5 is a cross-sectional view showing an entire construction of a fluid injection valve according to a third embodiment of the present invention;

FIG. 6 is a cross-sectional view showing an entire construction of a fluid injection valve according to a fourth embodiment of the present invention; and

FIG. 7 is a cross-sectional view showing a conventional fluid injection valve.

### DETAILED DESCRIPTION OF PREFERRED EMBODIMENTS

### First Embodiment

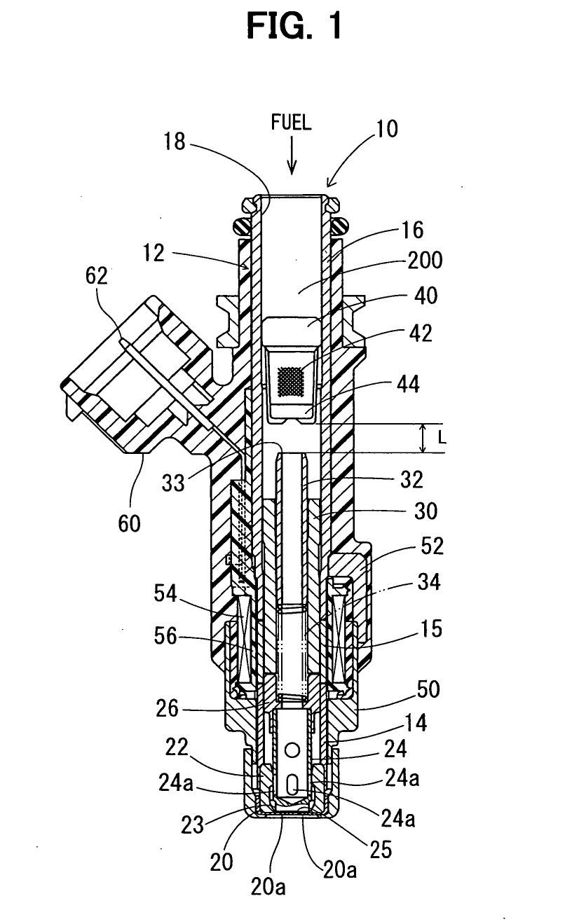

FIG. 1 depicts a fuel injection valve (fluid injection valve) according to a first embodiment of the present invention. The fuel injection valve 10 according to the first embodiment is installed in an air intake pipe that is connected to a combustion chamber of a gasoline engine, for example, and injects fuel into an intake air flowing through an air intake passage formed from the air intake pipe. The fuel injection valve 10 may also be applied to a direct injection gasoline engine that directly injects fuel into the combustion chamber of the gasoline engine, or to a diesel engine.

A pipe member 12 of the fuel injection valve 10 has a first magnetic pipe 14, a non-magnetic pipe 15 and a second magnetic pipe 16 that are arranged in this order from a side of an injection port plate on which injection holes 20a are formed. The first magnetic pipe 14 is connected to the non-magnetic pipe 15, and the non-magnetic pipe 15 is connected to the second magnetic pipe 16 by welding and the like. Inside the pipe member 12 are installed a valve body 22, a valve element 24, a moving core 26, a fixed core 30, an adjusting pipe 32, a spring 34 and a fuel filter 40.

The first magnetic pipe 14 installs the valve body 22 inside an inner circumferential wall thereof at an end portion opposite from the non-magnetic pipe 15, and is connected to the valve body 22 by welding and the like. The non-magnetic pipe 15, which serves as a magneto-resistance portion, is installed between the first magnetic pipe 14 and the second magnetic pipe 16. The non-magnetic pipe 15 prevents the first magnetic pipe 14 and the second magnetic pipe 16 from establishing magnetic short circuit. The second magnetic pipe 16 extends to an upstream end portion of the fuel injection valve 10, which is opposite from the injection port plate 20, and forms a fuel passage 200 therein in the upstream end portion.

The injection port plate 20 is connected to an outer wall of a bottom portion of the valve body 22 by welding and the like. On the injection port plate 20 are formed the injection holes 20a for injecting the fuel.

On an inner wall face of the valve body 22 is formed a valve seat 23 on which the valve element 24 seats. The valve element 24 is formed in a voided cylindrical shape with a bottom, and has a contact portion 25 on its bottom portion, which is to seat on the valve seat 23. On an upstream side of the contact portion 25 is formed a communication hole 24a to penetrate a side wall of the valve element 24. The fuel, which is flown from a side of the moving core 26 into the valve element 24, passes through the communication hole 24a and flows outward from an inside of the valve element 24 to an outside to be lead to a valve portion, which is formed from the contact portion 25 and the valve seat 23.

The moving core 26 is connected to a side of the valve element 24 opposite from the valve body 22 by welding and the like. The fixed core 30 is installed at an opposite side from the valve seat 23 with respect to the moving core 26 to face the moving core 26, and fixed in the pipe member 12. The moving core 26, the fixed core 30 and a coil 54, which are described below, correspond to an electromagnetic driving portion of the present invention.

The moving core 26, the fixed core 30 and the adjusting pipe 32 are cylindrical elements opened to both sides in an axial direction, and the fuel flows therein. The spring 34, which serves as an urging member, is engaged at its one end with the adjusting pipe 32 and at the other end with the moving core 26. An urging force of the spring 34 is adjusted by adjusting a press-fitting insertion amount of the adjusting pipe 32.

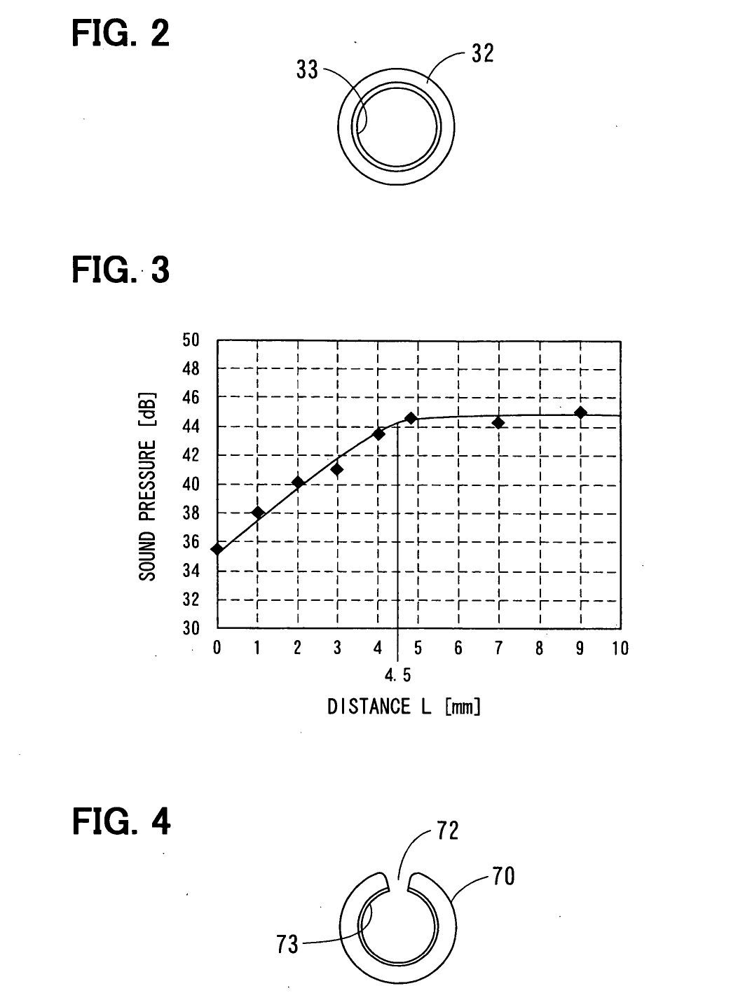

The adjusting pipe 32 is formed in a cylindrical shape, which is closed over an entire circumference (refer to FIG. 2, in which the adjusting pipe 32 is seen from a side of the fuel filter 40). The adjusting pipe 32 is press-fitted into an inside of the fixed core 30, and protrudes from the fixed core 30 toward the fuel filter 40. A passage diameter of an opening portion 33 of the adjusting pipe 32 at a side of the fuel filter 40 is smaller than a passage diameter of the fuel passage 20 in which the fuel filter 40 is installed. The adjusting pipe 32 corresponds to a passage portion and an engagement element of the present invention.

The fuel filter 40 is press-fitted into an inside of the second magnetic pipe 16, and installed in the fuel passage 200, which is at an upstream side of the fixed core 30 and the adjusting pipe 32. The fuel filter 40 is formed in a cup-like shape with a bottom, and a mesh-like filter body 42 is supported by a support frame 44 to cover a side face of the fuel filter 40. A downstream-side bottom portion of the fuel filter 40 is blocked by the support frame 44. The fuel filter 40 removes foreign matters contained in the fuel, which is flown from the fuel inflow port 18 into the inside of fuel injection valve 10, by the filter body 42.

Yokes 50, 52 are magnetically connected to each other, and cover an outer circumference of the coil 54. The yoke 50 is connected to the first magnetic pipe 14 at a radially outer side of the moving core 26. The yoke 52 is connected to the second magnetic pipe 16 at a radially outer side of the fixed core 30. The coil 54 is wound on a spool 56, and installed on an outer circumference of the pipe member 12. The resin housing 50 covers outer circumferences of the pipe member 12, the yoke 50, 52 and the coil 54. A terminal 62 is electrically connected to the coil 54, and supplies driving current to the coil 54.

Next, an operation of the fuel injection valve 10 is described.

When the coil 54 is energized, a magnetic flux flows through a magnetic circuit formed from the yokes 50, 52 the first magnetic pipe 14, the second magnetic pipe 16, the moving core 26 and the fixed core 30 in accordance with a magnetic field generated by the coil 54. By the magnetic flux flowing through the above-mentioned magnetic circuit, a magnetic attraction force is generated between the fixed core 30 and the moving core 26, and the moving core 26 is attracted to a side of the fixed core 30 and engaged with the fixed core 30. Then, the valve element 24 moves upward in FIG. 1 in accordance with the moving core 26 attracted to the side of the fixed core 30. Further, the fuel, which is flown from the fuel inflow port 18 into the inside of the fuel injection valve 10, passes through the fuel filter 40, each of inner passages of the adjusting pipe 32, the fixed core 30 and the moving core 26, an inside of the valve element 24 and the communication hole 24a, then through the outside of the valve element 24 and an opening between the contact portion 25 and the valve seat 23, and is injected from the injection holes 20a formed on the injection port plate 20.

When the current supply to the coil 54 is stopped, the magnetic attraction force between the fixed core 30 and the moving core 26 extinguishes. As a result, the moving core 26 moves apart from the fixed core 30 by the urging force of the spring 34. Also the valve element 24 moves apart from the fixed core 30, that is, toward the valve seat 23. When the contact portion 25 of the valve element 24 seats on the valve seat 23 of the contact portion 25, fuel injection is interrupted.

In a case that the current supply to the coil 54 is turned on and off and the valve element 24 reciprocatingly moves, the hitting sounds are generated when the valve element 24 seats on the valve seat 23 in a valve-closing time and when the moving core 26 is engaged with the fixed core 30. The operational sound, which is generated in this manner by a reciprocating movement of the valve element 24, is propagated from the side of the moving core 26 toward the fuel filter 40 passing through the inner passage of the fixed core 30 and the inner passage of the adjusting pipe 32. At this time, the passage diameter of the fuel passage 200 in which the fuel filter 40 is installed is larger than the passage diameter of the opening portion 33 of the adjusting pipe 32, so that a vibration of the sound going from the opening portion 33 toward the fuel filter 40 goes in a cone-like fashion toward the fuel filter 40 as increasing its amplitude.

In this regard, FIG. 3 depicts a relation between a distance L and a sound pressure of the operational sound that is propagated from the fuel injection valve 10 to the outer side, when a distance between the opening portion 33 of the adjusting pipe 32 and the fuel filter 40 is symbolized as L. As shown in FIG. 3, when the distance L is in L≦4.5 mm, the sound pressure decreases as the distance L becomes short. This is because the vibration of the sound, which goes from the opening portion 33 of the adjusting pipe 32 toward the fuel filter 40 as conically spreading, collides on the bottom portion of the support frame 44 of the fuel filter 40 before reaching the passage diameter of the fuel passage 200, in which the fuel filter 40 is installed. Thus, the vibration of the sound diffracts to an outer circumferential side of the fuel filter 40, to be prevented from being propagated from the fuel inflow port 18 to the outer portion of the injection valve 10 by passing through the filter body 42. Accordingly, by setting the distance L in a range of L≦4.5 mm, it is possible to reduce the sound that is propagated from the inside of the injection valve 10 to the outside. It is allowable that the distance L is 0, that is, the fuel filter 40 is in contact with the adjusting pipe 32.

Further, in the first embodiment, the fuel filter 40 is formed in the cup-like shape with the bottom, so that it is possible to increase a filtering area of the fuel filter 40 easily by extending an axial length of the filter body 40 covering the side face of the fuel filter 40. Furthermore, it is allowable that a part of the support frame 44 covering the bottom portion of the fuel filter 40 is substituted by the filter body to increase the filtering area, as demanded.

### Second, Third and Fourth Embodiments

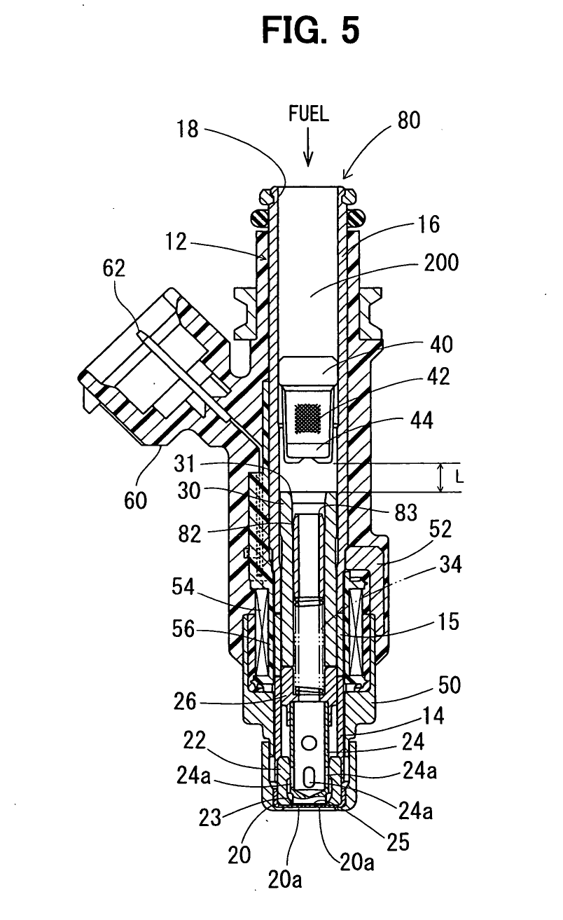

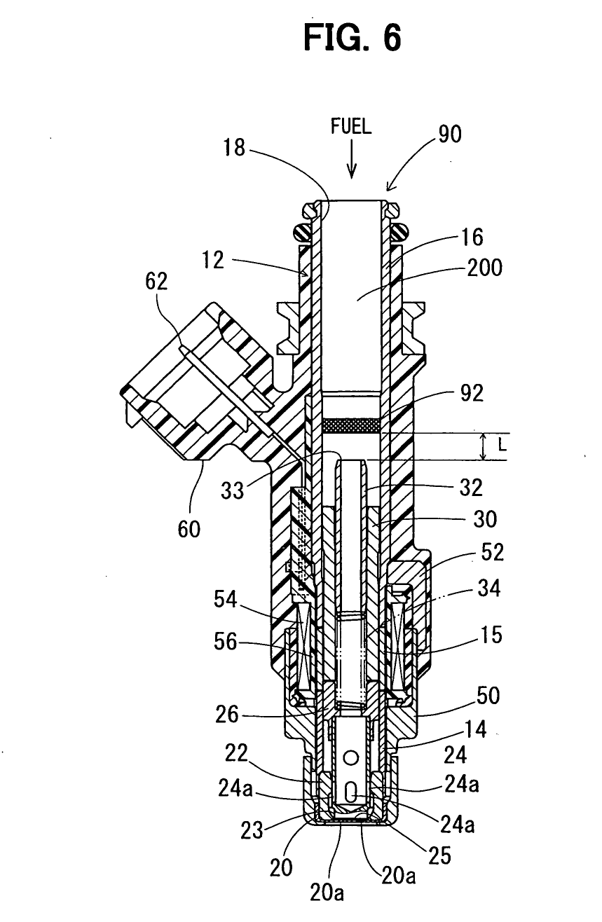

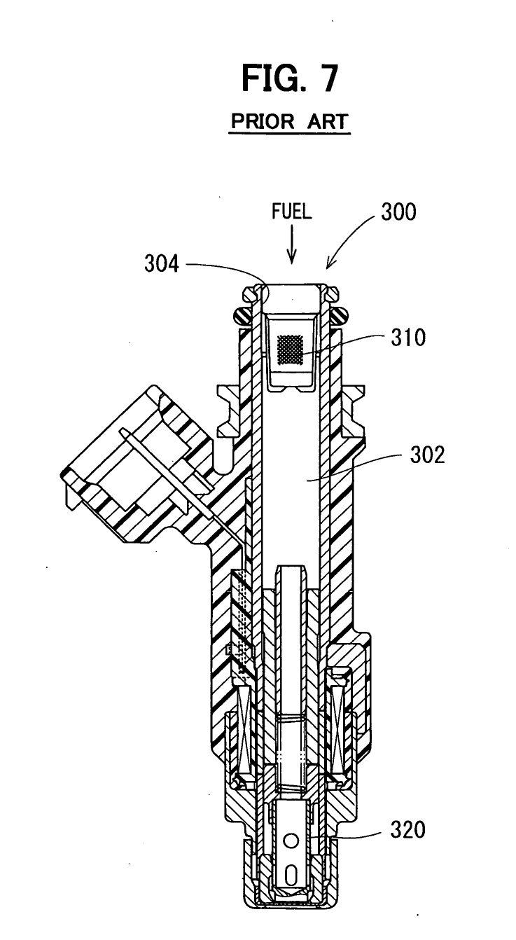

FIG. 4 depicts a second embodiment, FIG. 5 depicts a third embodiment and FIG. 6 depicts a fourth embodiment of the present invention. Substantially the same construction portions as in the first embodiment are assigned the same referential numerals.

In the second embodiment shown in FIG. 4, a communication passage 72, which penetrates the side wall of the pipe 70 serving as a passage portion and an engagement element and communicates the inside and the outside of the adjusting pipe 70 over an entire axial length of the adjusting pipe 70. By this construction, the fuel passed through the fuel filter 40 flows into the inside of the adjusting pipe 70 from the communication passage 72 in addition to flowing from the opening portion 73 of the adjusting pipe 70. Accordingly, a fuel amount flown into the adjusting pipe 70, of which the passage diameter is smaller than that of the fuel passage 20 in which the fuel filter 40 is installed, increases.

In a fuel injection valve 80 according to a third embodiment shown in FIG. 5, an axial length of the adjusting pipe 82 is short, and an opening portion 83 of the adjusting pipe 82 at the side of the fuel filter 40 is retracted to a downstream side from the opening portion 31 of the fixed core 30 at a side of the fuel filter 40. Accordingly, in the third embodiment, the fixed core 30 corresponds to a passage portion of the present invention.

Further, in the third embodiment, by setting the distance L between the opening portion 31 of the fixed core 30 and the fuel filter 40 in the range of L≦4.5 mm, the vibration of the sound, which goes from the opening portion 31 of the fixed core 30 toward the fuel filter 40 as conically spreading, collides on the bottom portion of the fuel filter 40 before reaching the passage diameter of the fuel passage, in which the fuel filter 40 is installed. Accordingly, it is possible to prevent the vibration of the sound from diffracting to the outer circumferential side of the fuel filter 40, so that it is possible to decrease the sound pressure of the operational sound, which is generated in the inside of the fuel injection valve 80 and propagated to the outside of the fuel injection valve 80.

In the fuel injection valve 90 according to a fourth embodiment shown in FIG. 6, the fuel filter 92 is formed in a plate-like shape from a porous construction body. Then, the fuel filter 92 is press-fitted into the inner circumferential wall of the second magnetic pipe 16, and installed in the fuel passage 200 at the upstream side of the fixed core 30 and the adjusting pipe 32. The distance L between the adjusting pipe 32, which protrudes from the fixed core 30 to the side of the fuel filter 92, and the fuel filter 92 is set in a range of L≦4.5 mm. Accordingly, it is possible to decrease the sound pressure of the operational sound, which is generated in the inside of the fuel injection valve 80 and propagated to the outside of the fuel injection valve 80.

### Other Embodiments

In the above-described embodiments explained above, the one end of the spring 34 is engaged with the adjusting pipe, however, the one end of the spring may be engaged with a step that is provided on the inner circumferential wall of the fixed core, for example, without using the adjusting pipe.

Further, in the above-described embodiments, the fixed core 30 or the adjusting pipe, which is installed at the downstream side of the fuel filter to face the fuel filter, forms the passage portion mentioned in Scope of Claims, however, other members such as a passage member forming the fuel passage may form the passage portion, other than the fixed core 30 and the adjusting pipe.

In the above-described second embodiment, the communication passage 72 is formed over the entire of the adjusting pipe 70 in the axial direction, however, the communication passage may be formed only in a portion in which the adjusting pipe 70 protrudes from the fixed core 30. In this case, the communication passage may be a slit-like shape extending from the opening portion 73 to the downstream side as in the second embodiment, or may be a communication passage formed to penetrate the side wall at a downstream side than the opening portion 73.

This description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fluid injection valve comprising:
a housing that is provided with a valve seat at a downstream portion thereof;
a fuel filter that is installed in an upstream portion of the housing;
a valve element that is slidably installed in the housing to lift off and seat on the valve seat; and
a passage portion that is provided in the housing between the fuel filter and the valve element to face the fuel filter and has an opening portion at an upstream end thereof, an inner width of the opening portion being narrower than a bore of the upstream portion of the housing and a distance between the opening portion and the fuel filter being 4.5 mm or greater; and
an electromagnetic driving portion that drives the valve element to open and close the valve seat.

2. The fluid injection valve according to claim 1, wherein the electromagnetic driving portion includes a fixed core that is fixedly installed in the housing, a moving core that is slidably installed in the housing to move integrally with the valve element and to face the fixed core, and a coil that generates a magnetic attraction force when it is energized between the fixed core and the moving core; and
the fixed core forms the passage portion.

3. The fluid injection valve according to claim 1, further comprising:
a spring that urges the valve element toward the valve seat; and
an engagement element that is fixed on an inner circumference of the fixed core to engage one end of the spring and protrudes from the fixed core toward the fuel filter, wherein:
the electromagnetic driving portion includes a fixed core that is fixedly installed in the housing, a moving core that is slidably installed in the housing to move integrally with the valve element and to face the fixed core, and a coil that generates a magnetic attraction force when it is energized between the fixed core and the moving core; and
the engagement element forms the passage portion.

4. The fluid injection valve according to claim 3, wherein the engagement element has a communication passage at a portion protruded from the fixed core to communicate an inside and an outside of the engagement element.

5. The fluid injection valve according to claim 1, wherein the fuel filter is formed in a cup-like shape.
